(19) United States
(12) Patent Application Publication
(10) Pub. No.: US 2006/0035382 A1
(43) Pub. Date: Feb. 16, 2006

(54) Method of analyzing metabolism for animal, method of producing labeled animals, labeled animals and method of measuring NMR for animals

(75) Inventors: Kazuo Shinozaki, Tsukuba-shi (JP); Takashi Hirayama, Tsukuba-shi (JP); Jun Kikuchi, Yokohama-shi (JP); Takashi Nishihara, Yokohama-shi (JP)

Correspondence Address: FOLEY AND LARDNER LLP;SUITE 500, 3000 K STREET NW, WASHINGTON, DC, 20007, US

(73) Assignee: RIKEN

(21) Appl. No.: 11/083,103

(22) Filed: Mar. 18, 2005

(30) Foreign Application Priority Data
Aug. 13, 2004 (JP) 2004-236189

(51) Int. Cl. G01N 24/00

(52) U.S. Cl. 436/56; 436/173

(57) ABSTRACT

The present invention provides a novel NMR metabolomics method for observing an animal by labeling the animal itself. A labeled animal labeled with a stable isotope is produced by feeding an animal a labeled food labeled with the stable isotope. Metabolism of a biological substance in the animal is analyzed based on nuclear magnetic resonance data of the biological substance containing the stable isotope. The nuclear magnetic resonance data is acquired by performing NMR measurement on a body of the labeled animal, a portion of the body, or an extract.

### CROSS-REFERENCE TO RELATED APPLICATIONS

The present document incorporates by reference the entire contents of Japanese priority document, 2004-236189 filed in Japan on Aug. 13, 2004.

### BACKGROUND OF THE INVENTION

1. Field of the Invention

The present invention relates to a method of analyzing metabolism for animal, a method of producing labeled animals, labeled animals used in the method of analyzing, and a method of measuring nuclear magnetic resonance for animals.

2. Description of the Related Art

In the current post-genome age, researches on living organisms based on understanding that the living organism is one form of system are necessary. Current metabolomics research primarily employs a mass spectrometry (MS), which is a technique for analyzing the metabolism of living organisms using a mass spectrometer. The MS is a method of observing metabolites based on differences in times of flight of compounds. The difference in times attributes to differences in weights of molecules of ionized compounds. Recently, comprehensive analyses have come to be performed using LC-MS, in which liquid chromatography (LC) used for separation purposes is combined with the MS, for the purpose of analyzing metabolic components in a living body roughly classified based on solubility in a solvent, thereby simplifying identification of metabolites and analysis of fluctuations.

However, the MS encounters difficulties in quantitative analysis of mixed samples due to prominent differences in degrees of ionization caused by certain types of compounds referred to as ion suppressors, and the lack of the development of a methodology enabling separation of complex and overlapping signals. In addition, since the MS requires ionization, non-invasive measurement is theoretically impossible, and in vivo measurement is impossible. Furthermore, with the MS, only information on molecular weight and semi-quantitative information on the amounts of substances present, and it is theoretically impossible to use the MS for quantifying molecular mobility.

On the other hand, numerous NMR metabolomics methods using urine for analyzing pathological states of higher animals have been reported as analytical techniques other than the MS. It is considered that such methods are developed because of great sampling ease and the number of intrinsic metabolites contained in urine being small. However, urine is merely a waste product of an animal, and there have been hardly any report on the NMR metabolomics methods of which a target of observation is a living body of an animal, a tissue, an organ, or the like.

However, multidimensional NMR is widely used in the fields of protein identification and structural analysis. Due to its superior reproducibility and quantitative properties, if multidimensional NMR can be applied to metabolomics research, it will be possible to analyze the metabolism of biological substances that have thus far been difficult to measure. However, the nuclides such as ¹³C and ¹⁵N used in multidimensional NMR have the problem of extremely low detection sensitivity due to low natural abundance ratios thereof.

When measuring NMR of nuclides having low natural abundance ratios, conventionally, such a method has been typically used that a specific compound to be measured is labeled with a stable isotope to improve measurement sensitivity. For example, since the natural abundance ratio of ¹³C is 1.1% and the natural abundance ratio of ¹⁵N is 0.4%, if 100% labeling is possible, it will be possible to observe 100 times the amount of nuclei present in the case of ¹³C, and 250 times the amount in the case of ¹⁵N. An example of a method used to label a specific compound to be measured includes establishing an expression system for a protein to be measured using genetically manipulated escherichia coli, and expressing the protein in a medium containing a nutrient labeled with a stable isotope. Thus, a protein labeled with the stable isotope is obtained.

However, there have been no reports on methods for labeling a body of an animal, and such methods have yet to be established.

### SUMMARY OF THE INVENTION

In view of the above problem, it is an object of the present invention to provide a novel NMR metabolomics method for observation targeting an animal by labeling an animal itself.

As a result of conducting assiduous study to solve the above problems, the inventors of the present invention have found that a labeled animal that is labeled with a stable isotope can be obtained by feeding an animal food that is labeled with a stable isotope, thereby leading to completion of the present invention on the basis of this finding.

Accordingly, the present invention is summarized as follows:

(1) A method of analyzing metabolism of an animal includes producing a labeled animal that is labeled with a stable isotope by feeding an animal a labeled food labeled with the stable isotope; acquiring information on nuclear magnetic resonance data of a biological substance that contains the stable isotope by performing NMR measurement on any one of a body of the labeled animal, a portion of the body, and an extract; and analyzing metabolism of the biological substance in the animal based on the information.

(2) In the method according to aspect (1), the labeled food is labeled with at least one type of stable isotope of ¹³C and ¹⁵N.

(3) In the method according to aspect (1) or (2), the animal is a silkworm.

(4) A method of producing a labeled animal that is labeled with a stable isotope includes feeding an animal a labeled food labeled with the stable isotope.

(5) A labeled animal that is labeled with a stable isotope is obtained by the method according to aspect (4).

(6) A portion of a labeled animal that is labeled with a stable isotope is obtained by the method according to aspect (4).

(7) A method of measuring NMR of an animal includes producing a labeled animal that is labeled with a stable isotope by feeding an animal a labeled food labeled with the stable isotope; and acquiring information on nuclear magnetic resonance of a biological substance that contains the stable isotope by performing NMR measurement on any one of a body of the labeled animal, a portion of the body, and an extract.

According to the present invention, since a labeled animal can be produced in which a stable isotope is incorporated in a body thereof, analysis of metabolism using the NMR can be performed even for the nuclides having low natural abundance ratios, such as ¹³C and ¹⁵N. In addition, the present invention also enables in vivo measurement, which has not been possible with the MS, since it allows non-invasive measurement by using the NMR.

### BRIEF DESCRIPTION OF THE DRAWINGS

FIG. 1 is a schematic for illustrating a two-dimensional ¹⁵N-HSQC spectrum of plasma lymph of a silkworm that is labeled with ¹⁵N;

FIG. 2 is a schematic for illustrating ¹⁵N-HSQC spectra of a silk gland, the plasma lymph, and a fat body of the silkworm that is labeled with ¹⁵N; and

FIG. 3 is a schematic for illustrating two-dimensional ¹³C-HSQC spectra of plasma lymph and a fat body of a silkworm that is labeled with ¹³C.

### DETAILED DESCRIPTION OF THE PREFERRED EMBODIMENTS

Exemplary embodiments of the present invention are explained below. In the method for analyzing metabolism of an animal according to the present invention, a labeled animal that is labeled with a stable isotope is produced by feeding an animal a labeled food that is labeled with a stable isotope, and NMR measurement is performed on the labeled animal produced. Thus, metabolism of a biological substance in an animal is analyzed.

First, the labeled food to be fed to the animal is explained. The labeled food is a food that is labeled with a stable isotope. The stable isotope is a stable isotope of a nuclide for which measurement sensitivity is desired to be enhanced. For example, the stable isotope includes ²H, ⁷Li, ¹¹B, ¹³C¹⁵N, ¹⁷O, ¹⁸O, ²⁹Si, ³³S, ¹³Ca, ¹⁷Ti, ¹⁷Fe, ¹³Cu, ⁶⁷Zn, ⁷⁷Se, ⁷⁹Br, ¹⁰⁹Ag, ¹¹⁵Sn, ¹²⁹Xe, and ¹⁹⁹Hg. A labeled food that is labeled with two or more types of stable isotopes, such as ¹³C and ¹⁵N, may be used.

A labeled food should be able to label an animal as a result of being digested and absorbed after being ingested by an animal, by at least a part of which becoming a biological substance that composes a body of the animal. All compounds that compose-the labeled food are not required to be uniformly labeled. For example, a labeled food can be used in a manner that an organic substance that can be absorbed by the animal is labeled, and then mixed with a food that is not labeled. However, since an animal cannot be labeled with a food labeled with a substance that is excreted outside the body without being absorbed at all in the body, even if mixed with other foods, such substance is not applicable to the labeled food in the present invention.

A food to be used for the labeled food should be a food that is easily ingested by the animal of which metabolism is to be analyzed. For example, for an herbivorous animal, a plant that is labeled with a stable isotope should be given as a labeled food, while for a carnivorous animal, an animal that is labeled with a stable isotope should be given as a labeled food. A labeled animal having a high labeling rate can be produced by having the animal ingest a labeled food having a high labeling rate.

In the ecosystem, plants that produce organic substances by photosynthesis using solar energy positioned at a starting point of the food chain, and all animals live by consuming the organic substances produced by the plants directly or indirectly as nutrient sources. Food sources of herbivorous animals that serve as food sources of carnivorous animals are plants. Therefore, explanation of the labeled food starts with plants serving as nutrient sources for all animals. A plant labeled with a stable isotope (hereinafter, “labeled plant”) can be produced by providing the plant with a nutrient source that is labeled with at least one type of stable isotope during the course of raising the plant. To produce a labeled plant having a high labeling rate, it is preferable that the nutrient source labeled is provided to the plant at an early stage of development of the plant, namely from a stage of a seed or a germinating seedling.

To produce a labeled plant, at least one type of nutrient source selected from nutrient sources required for plant growth is labeled with a stable isotope and supplied to the plant during the course of development. A “nutrient source” refers to all substances essential for plant development. Nutrient sources required for plant development can be broadly classified into CO2 and H2O used in photosynthesis, and nutrients such as nitrogen sources, phosphate sources, potassium sources, magnesium sources, calcium sources, trace element sources, and nutriment such as metals.

Among nutrient sources, CO2 is a nutrient source that is absorbed through the leaves, while nutrient sources other than CO2 are primarily absorbed through the roots. When labeling a nutrient source that is absorbed through leaves, such as CO2, the plant should be raised in an atmosphere containing labeled 13CO2. When labeling with a nutrient source that is absorbed through the roots, the plant should be raised in a plant bed containing a labeled nutrient source (for example, nutrient source labeled with ¹⁵N).

When producing a labeled plant with labeled CO₂, it is preferable that a plant is raised in a sealed container to which the labeled CO2 is supplied. In this case, since ethylene produced-by the plant accumulates in the sealed container and the ethylene accumulated sometimes has a detrimental effect on plant development, it is preferable that an ethylene-insensitive mutant strain is used.

When the animal for which metabolism is to be analyzed is one capable of ingesting plants as food, a labeled plant produced by a method described above should be given to the animal after putting the labeled plant into an easily ingested form. For example, when metabolism of a silkworm is analyzed, since silkworms ingest mulberry leaves as their food source, a mulberry plant should be labeled and mulberry leaves obtained from the labeled mulberry plant should be made to be ingested by the silkworm as the labeled food. Alternatively, a labeled plant is preferably produced using a plant that grows faster than mulberry (for example, Arabidopsis thaliana), and a mixture of such plant labeled and mulberry leaves unlabeled is made to be ingested by the silkworm as the labeled food.

When the animal for which metabolism is to be analyzed is one like a carnivorous animal, which has difficulty in ingesting plants as food, an herbivorous animal should be labeled by having the herbivorous animal ingest a labeled plant, and this herbivorous animal should be ingested by the carnivorous animal as a labeled food. Alternatively, a mixture of the labeled plant and meat may be prepared, and the mixture may be then ingested by the carnivorous animal.

Nuclear magnetic resonance data of biological substances that contains the stable isotope is then acquired by performing NMR measurement on the labeled animal obtained. In the present invention, biological substances of which metabolism is to be analyzed are biological substances that are labeled with a stable isotope.

First, an NMR measurement sample is prepared from the labeled animal obtained. A body itself of the labeled animal can be directly used as the NMR measurement sample, and a part (tissue, organ, etc.) of the body of the labeled animal or an extract obtained from the labeled animal can also be used for the NMR measurement sample.

NMR measurement is then performed on the NMR measurement sample obtained from the labeled animal to acquire the nuclear magnetic resonance data of the biological substances containing the stable isotope. There are no particular limitations on NMR measurement methods, and common measurement methods can be used. For example, one-dimensional observation methods and multi-dimensional observation methods may be used. For example, by combining various multi-dimensional observation methods for assigning chemical shifts (for example, DQF-COSY, TOCSY, NOESY, INADEQUATE, NOESY-HSQC, TOCSY-HSQC, HCCH-TOCSY, or HCCH-COSY), signals can be assigned more systematically. Namely, a measurement method suitable for a metabolite desired to be observed should be selected from among the common NMR measurement methods.

According to the present invention, various pieces of metabolic information on biological substances can be obtained by using the NMR. The information obtained by the NMR includes information on a type of compound (chemical shift) and its amount (peak intensity). In addition, information on mobility of a substance in the body can be obtained from a line width and intensity of a spectrum. Furthermore, nuclear magnetic imaging makes it possible to obtain an image that illustrates distribution of the biological substances within the body of the labeled animal.

To analyze the metabolism of the biological substances in an animal, information on the nuclear magnetic resonance data should be acquired for two or more samples having different metabolic conditions, and difference in the information between the samples should be analyzed. “Different metabolic conditions” includes not only a case of having different metabolic conditions due to a time course of metabolism in the same individual caused by changes in an environment (for example, temperature changes, ultraviolet rays, drying, or infection by pathogens) surrounding the animal, but also a case of different metabolic conditions at different sites in the same individual as well as a case of different metabolic conditions between genetically different individuals. For example, how stress affects an animal internally can be determined by applying stress to the labeled animal and then analyzing quantitative changes in metabolites before and after applying the stress based on the differential spectrum. In addition, how a labeled food is digested, absorbed, and distributed in the body of the animal can be analyzed by having the animal ingest the labeled food. Furthermore, what kind of genetic difference affect expressed proteins can be determined by respectively producing labeled animals for normal animals and mutant animals, and then analyzing differences in types and amounts of proteins expressed in the body of the animals.

Furthermore, material circulation among living organisms can also be analyzed using the method for analyzing metabolism of an animal of the present invention. For example, how materials are incorporated and metabolized from lower organisms to higher organisms in the food chain, and how the materials are incorporated further to next organisms, can be analyzed for a food cycle that circulates in an order from plants to animals to bacteria and then back to the plants.

As explained above, according to the present invention, since a labeled animal can be produced by feeding an animal a labeled food that is labeled with a stable isotope, detection sensitivity can be improved even for nuclides such as 13C and 15N having low natural abundance ratios. Furthermore, widening of 1H signals due to anisotropy of a 1H-1H dipole interaction characteristic of biological samples can be prevented by uniformly labeling animals with a stable isotope. In addition, since the present invention allows non-invasive measurement, measurements can be performed in vivo, which has not been possible with the MS.

### EXAMPLES

The present invention is explained in more detail based on examples below. Note that the present invention is not limited to the examples below.

### Example 1

### Production of Labeled Animals (Silkworms)

(1) Production of a Labeled Plant (Arabidopsis thaliana)

A labeled plant uniformly labeled with a stable isotope was prepared for Arabidopsis thaliana. An ethylene-insensitive mutant strain ein2-5 was used for a label for Arabidopsis thaliana.

The mutant strain ein2-5 of Arabidopsis thaliana, variety Columbia was seeded in a plant bed that includes vermiculite and perlite (50% each (volume/volume)), and was maintained at 4° C. for 3 days to 4 days to promote germination. Germinating seedlings of the mutant strain ein2-5 were raised at 22° C. to 23° C. using a light-dark cycle of 16 hours of daylight and 8 hours of night. During the course of development, nutrient salts of the composition indicated below (all concentrations are final concentrations) were provided once a week.

| | | |
|---|---|---|
| KNO₃ | 5 | millimoles (mM) |
| KPO₃ (pH 5.5) | 2.5 | mM |
| MgSO₄ | 2 | mM |
| CaCl₂ | 2 | mM |
| Fe EDTA | 50 | micromoles (μM) |
| H₃BO₃ | 70 | μM |
| MnCl₂ | 14 | μM |
| CuSO₄ | 0.5 | μM |
| ZnSO₄ | 1 | μM |
| NaMoO₄ | 0.2 | μM |
| NaCl | 10 | μM |
| CoCl₂ | 10 | nanomoles (nM) |

(a) Production of a ¹³C-Labeled Plant

Labeling with 13C was carried out by preparing a sealed acrylic chamber, filling the chamber with 13CO2 at 340 parts per million (ppm), and growing a plant inside the chamber. The atmosphere in the chamber was replaced every 2 to 3 days by pumping in 340 ppm of 13CO2 for ventilation. A 13C labeling rate of the labeled plant after 30 days of growing was about 30%.

(b) Production of a 15N-Labeled Plant

In a case of 15N labeling, a 15N-labeled plant was produced by providing 15KNO3 instead of a nutrient salt KNO3 described above until the plant produced seeds and died. A 15N labeling rate of the labeled plant after 30 days of being raised was about 98%.

(2) Production of a Labeled Food

A labeled plant obtained by the above method was crushed with a mortar in liquid nitrogen, and then applied to a centrifugal evaporator for 2 days to evaporate contaminants. Thus, a labeled plant powder was obtained. A mulberry leaf powder was prepared by grinding mulberry leaves organically cultivated and dried for a purpose of manufacturing mulberry tea into a powder. The mulberry leaf powder, the labeled plant powder, agar, and water were mixed at a ratio indicated below, and then steamed for 5 minutes after mixing together. Material steamed was then mixed again while the material is still hot. A feed thus obtained was formed into strips and used as a labeled food.

| | | |
|---|---|---|
| mulberry leaf powder | 15.8% | (weight (w)/weight (w)) |
| labeled plant powder | 6.9% | (w/w) |
| agar | 5.8% | (w/w) |
| water | 70.2% | (w/w) |

When a labeled plant that was not evaporated with a centrifugal evaporator was used, the silkworms did not eat at all and died. Moreover, although the silkworms were attempted to be fed the feed after changing a blending ratio of labeled plant to mulberry leaf powder to 7:3 or more, an amount eaten was too small, and it caused a fat body to atrophy in a healthy individual. On the other hand, with an above composition of the feed, the silkworms continued to eat the feed for 3 days as much amount as the silkworms eat when commercially available artificial feed is given.

(3) Silkworm Labeling

Silkworms were labeled by feeding the silkworms the labeled food described above at each stage of fifth instar.

### Example 2

Each of silkworms at an early stage, an intermediate stage, and a final stage of the fifth instar were labeled by feeding a labeled food at different feeding times and time periods. The NMR measurement was performed on tissues extracted from each of the silkworms labeled to confirm a condition that resulted in the highest labeling rate.

The silkworms labeled were dissected after anesthetizing with ice to extract plasma lymph, fat bodies, silk glands and Malpighian tubules. Each of the tissues extracted were frozen with liquid nitrogen and crushed, and then dissolved in dimethyl sulfoxide (DMSO) and transferrin receptor (TFR). Body fluid was not removed and allowed to remain in the tissues this time. Insoluble matter was removed by centrifugation, and supernatant was used as the NMR measurement sample.

Multi-dimensional NMR measurements were performed on the NMR measurement samples obtained using a Bruker 500 MHz NMR spectrometer and trinuclear probe equipped with a triaxial gradient. 15N-HSQC measurement was performed by removing water signals contained in a large amount in the sample using a water-flip-back method (Grzesiek & Bax, 1993) and typically measuring by integrating 16 times to 160 times for 1024 points (f2 axis)×128−256 points (f1 axis). Free induction decay (FID) data was processed by performing a fourier conversion using an nmrPipe program (Delagrio, et al, 1995), and a zero filling processing.

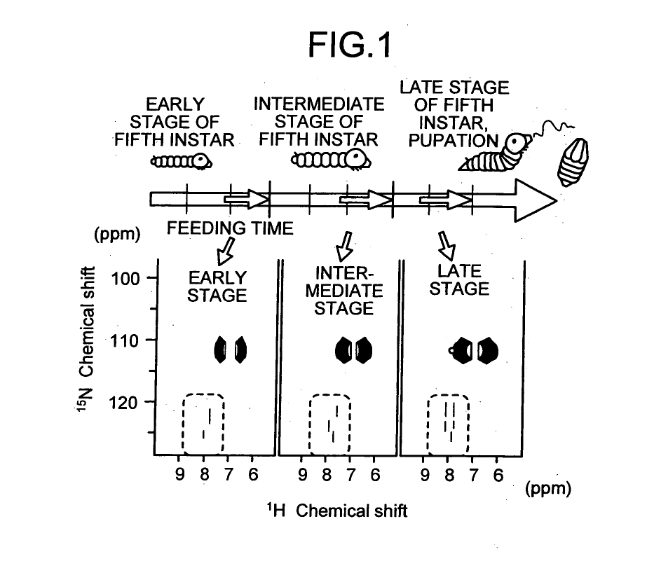

A two-dimensional 15N-HSQC spectrum of plasma lymph of silkworms labeled with 15N is shown in FIG. 1. Labeling rates of the plasma lymph varied due to differences in times when the silkworms were fed, and it is observed that the labeling rates increase in order from the early stage, the intermediate stage, to the final stage.

### Example 3

A ¹⁵N-HSQC spectrum of each of silk glands, plasma lymph, and fat bodies of silkworms labeled with ¹⁵N were measured. The method for preparing the NMR measurement samples and the measurement conditions were the same as in those used in Example 2.

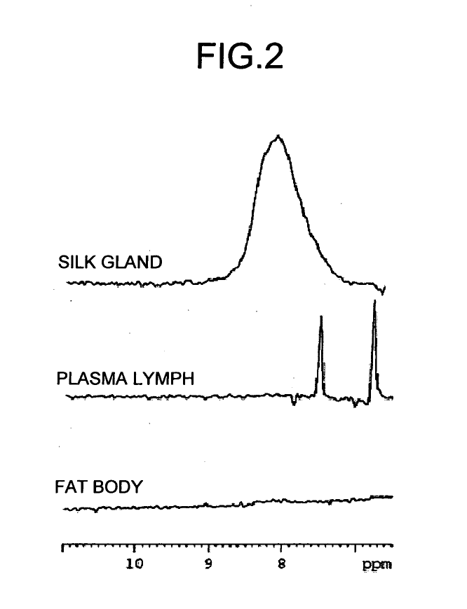

The 15N-HSQC spectrum of each of silk glands, plasma lymph, and fat bodies of the silkworms labeled with 15N is shown in FIG. 2. In animal tissue, each tissue has distinct compositions of compounds, and the NMR spectrum shows such distinction very clearly. For example, fibroin protein is present in an overwhelmingly large amount in silk glands, and a signal of the NH derived from peptide bonds of a main peptide chain can be observed at around 8 parts per million (ppm). On the other hand, side chain amide signals of Gln and Asn, which characteristically serve as nitrogen supply sources of larvae, can be clearly observed in the plasma lymph. However, in a fat body tissue, lipids, cholesterol, and phospholipids, which are characteristic of animal cells, form nearly entire tissue, and an amount of compounds containing NH bonds is extremely low. Therefore, no signals can be observed.

### Example 4

A two-dimensional ¹³C-HSQC spectrum of each of plasma lymph and a fat body of silkworms labeled with ¹³C was measured. The method used to prepare NMR measurement samples and measurement conditions were the same as those used in Example 2.

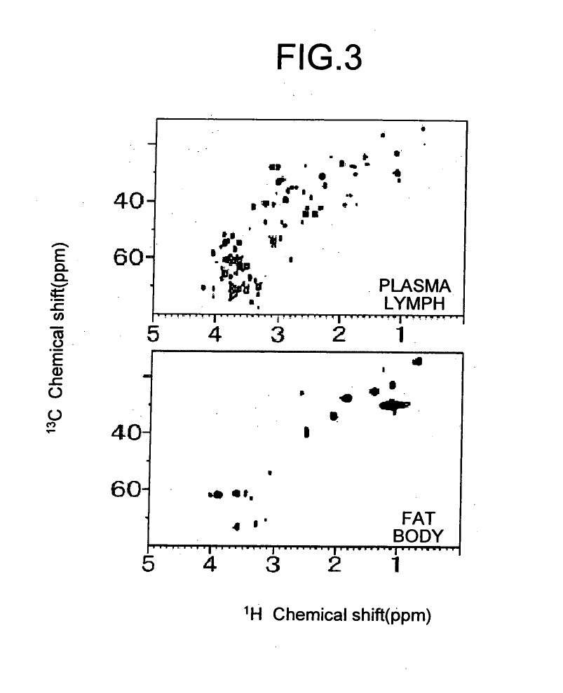

The two-dimensional 13C-HSQC spectrum of each of the plasma lymph and the fat body of the silkworms labeled with 13C is shown in FIG. 3. Cross signals of various types of low molecular metabolites can be observed in the plasma lymph. In fat bodies, on the other hand, since constituent molecules are only lipids, a spectral pattern is simple in reflection of hydrocarbon chains. The present research is the first research in the world to display differences of constituent molecules that are distinctive of each tissue in a cell of an animal in a form of overall spectra using multi-dimensional NMR.

As described above, the present invention is useful for analyzing metabolism of an animal using NMR, and can be particularly applied to discover metabolic abnormalities in an animal and to determine a cause of the abnormalities, or to an applied research such as growth monitoring and quality control in fields of metabolic engineering and livestock products, analysis of effects of agricultural chemicals, food quality control and nutritional control, quality control of genetically modified animals, health control and diagnosis of diseases of animals including human, pharmaceutical effect analysis of animals including human, and nutritional control for sports as well as in basic research such as the simulation of life-sustaining activities in fields such as system biology.

1. A method of analyzing metabolism of an animal, the method comprising:
producing a labeled animal that is labeled with a stable isotope by feeding an animal a labeled food labeled with the stable isotope;
acquiring information on nuclear magnetic resonance data of a biological substance that contains the stable isotope by performing nuclear-magnetic-resonance measurement on any one of a body of the labeled animal, a portion of the body, and an extract; and
analyzing metabolism of the biological substance in the animal based on the information.

2. The method according to claim 1, wherein the labeled food is labeled with at least one type of stable isotope of ¹³C and ¹⁵N.

3. The method according to claim 1, wherein the animal is a silkworm.

4. A method of producing a labeled animal that is labeled with a stable isotope, the method comprising feeding an animal a labeled food labeled with the stable isotope.

5. A labeled animal that is labeled with a stable isotope, wherein the labeled animal is obtained by feeding an animal a labeled food labeled with the stable isotope.

6. A portion of a labeled animal that is labeled with a stable isotope, wherein the labeled animal is obtained by feeding an animal a labeled food labeled with the stable isotope.

7. A method of measuring nuclear magnetic resonance of an animal, the method comprising:
producing a labeled animal that is labeled with a stable isotope by feeding an animal a labeled food labeled with the stable isotope; and
acquiring information on nuclear magnetic resonance data of a biological substance that contains the stable isotope by performing nuclear-magnetic-resonance measurement on any one of a body of the labeled animal, a portion of the body, and an extract.
